(19) United States
(12) Patent Application Publication
(10) Pub. No.: US 2011/0199885 A1
(43) Pub. Date: Aug. 18, 2011

(54) Disk Unit

(75) Inventors: Katsunori ONISHI, Daito-shi (JP); Kazumasa Nasu, Daito-shi (JP); Kazutoshi Takemi, Daito-shi (JP)

(73) Assignee: Funai Electric Co., Ltd., Daito-shi (JP)

(21) Appl. No.: 13/025,685

(22) Filed: Feb. 11, 2011

(30) Foreign Application Priority Data
Feb. 12, 2010 (JP) 2010-28561

(51) Int. Cl. G11B 33/02; G11B 7/135

(52) U.S. Cl. 369/112.24; 720/600; G9B/33.002; G9B/7.112

(57) ABSTRACT

In this disk unit, a tray has an air intake opening formed to extend from an upstream side in a rotational direction of a disk rotated by a rotating portion toward an optical pickup and to extend inward from outside a receiving region from the upstream side toward a downstream side in the rotational direction for incorporating air into the side a receiving surface of the tray from the side of the back surface thereof.

### BACKGROUND OF THE INVENTION

1. Field of the Invention

The present invention relates to a disk unit, and more particularly, it relates to a disk unit including an optical pickup applying light to a disk.

2. Description of the Background Art

A disk unit including an optical pickup applying light to a disk is known in general, as disclosed in Japanese Patent Laying-Open No. 2008-251058, for example.

The aforementioned Japanese Patent Laying-Open No. 2008-251058 discloses an optical disk unit including an optical pickup applying a laser beam to a disk, a driving mechanism (rotating portion) supporting and rotating the disk, a mechanism body moving the optical pickup in the radial direction of the disk and a mechanism cover covering the mechanism body. In this optical disk unit, the mechanism cover is provided with an opening extending parallelly to the direction of movement of the optical pickup along the moving region of the optical pickup. This optical disk unit is formed to cool the optical pickup by incorporating an air current formed between the disk and the mechanism cover following rotation of the disk from the opening into a lower portion of the mechanism cover, on which the optical pickup is arranged.

In the optical disk unit according to the aforementioned Japanese Patent Laying-Open No. 2008-251058, however, the air current is incorporated into the lower portion of the mechanism cover from the opening extending parallelly to the direction of movement of the optical pickup along the moving region of the optical pickup, and hence it is conceivable that the air current incorporated into the lower portion of the mechanism cover is dispersed in the overall moving region of the optical pickup and cannot be intensively guided to the optical pickup as a result. Therefore, the optical pickup cannot be sufficiently cooled.

### SUMMARY OF THE INVENTION

The present invention has been proposed in order to solve the aforementioned problem, and an object of the present invention is to provide a disk unit capable of sufficiently cooling an optical pickup.

A disk unit according to an aspect of the present invention includes a tray capable of receiving a disk thereon, a rotating portion supporting the disk placed on the tray to be separated from a receiving surface of the tray and rotating the supported disk, and an optical pickup arranged on a side of the disk closer to the receiving surface for applying light to the disk, while the tray has an air intake opening formed to extend from an upstream side in a rotational direction of the disk rotated by the rotating portion toward the optical pickup in a receiving region receiving the disk and to extend inward from outside the receiving region from the upstream side toward a downstream side in the rotational direction for incorporating air into the side of the receiving surface of the tray from the side of the back surface of the tray opposite to the receiving surface.

As hereinabove described, the disk unit according to the aspect of the present invention is provided with the air intake opening for incorporating air into the side of the receiving surface of the tray from the side of the back surface thereof in the receiving region receiving the disk, whereby air can be incorporated (drawn) into the side of the receiving surface of the tray from the side of the back surface thereof through the air intake opening due to an air current formed between the disk and the receiving surface of the tray following rotation of the disk. Further, the air intake opening is formed to extend from the upstream side in the rotational direction of the disk rotated by the rotating portion toward the optical pickup in the receiving region receiving the disk and to extend inward from outside the receiving region from the upstream side toward the downstream side in the rotational direction so that air incorporated from the air intake opening extending toward the optical pickup is intensively guided to the optical pickup located on the downstream side of the air intake opening, whereby the optical pickup can be sufficiently cooled dissimilarly to a case where the air intake opening is formed to extend parallelly to the direction of movement of the optical pickup and air incorporated from the air intake opening is dispersed, for example. The effect of the disk unit capable of cooling the optical pickup has already been confirmed by a simulation conducted by the inventor, as described later.

In the disk unit according to the aforementioned aspect, the optical pickup is preferably formed to be movable in the radial direction of the disk, and the air intake opening of the tray is preferably formed to extend from the upstream side in the rotational direction of the disk toward the optical pickup at a sharp angle in the rotational direction of the disk with respect to the direction of movement of the optical pickup. According to this structure, the air intake opening can be easily formed to extend from the upstream side in the rotational direction of the disk rotated by the rotating portion toward the optical pickup and to extend inward from outside the receiving region from the upstream side toward the downstream side in the rotational direction, whereby the effect of cooling the optical pickup can be easily sufficiently improved.

In the disk unit according to the aforementioned aspect, the tray preferably further has an exposing opening for exposing at least the optical pickup on the side of the receiving surface of the tray, and the air intake opening of the tray is preferably in the form of a notch connected to the exposing opening in a portion of the air intake opening on the downstream side. According to this structure, no separating portion (separating wall) is provided between the air intake opening and the exposing opening and hence air incorporated from the air intake opening is guided to the optical pickup exposed in the exposing opening in a larger quantity dissimilarly to a case where the air intake opening and the exposing opening are separated from each other, whereby the optical pickup can be more sufficiently cooled.

In this case, the exposing opening is preferably provided in a shape capable of exposing both of the rotating portion and the optical pickup on the side of the receiving surface of the tray. According to this structure, a larger quantity of air can be incorporated (drawn) into the side of the receiving surface of the tray from the side of the back surface thereof through the exposing opening and the air intake opening having larger sizes, whereby the optical pickup can be further effectively cooled.

In the disk unit according to the aforementioned aspect, the optical pickup is preferably formed to be movable in the radial direction of the disk, and the air intake opening is preferably formed to extend toward a prescribed position on a movement path of the optical pickup. According to this structure, air incorporated from the air intake opening is intensively guided to the optical pickup located on the prescribed position on the movement path, whereby the optical pickup located on the prescribed position can be efficiently cooled.

In this case, the optical pickup is preferably formed to be movable between a first position on which the optical pickup is arranged when applying light to a portion of the disk close to the center thereof and a second position on which the optical pickup is arranged when applying light to another portion of the disk close to the outer periphery thereof, and the air intake opening of the tray preferably includes at least a first air intake opening formed to extend from the upstream side in the rotational direction of the disk rotated by the rotating portion toward the optical pickup arranged on the first position as the prescribed position. According to this structure, air is intensively guided to the optical pickup located on the first position, whereby the disk unit can efficiently cool the optical pickup reaching a high temperature when applying light to the portion of the disk close to the center thereof.

In the aforementioned structure having the air intake opening including the first air intake opening, the air intake opening of the tray preferably further includes a second air intake opening formed to extend from the upstream side in the rotational direction of the disk rotated by the rotating portion toward the optical pickup, in addition to the first air intake opening. According to this structure, the disk unit can efficiently cool the optical pickup also in a case where the optical pickup applies light to a portion of the disk other than the portion close to the center thereof in addition to the case where the optical pickup applies light to the portion of the disk close to the center thereof, whereby the optical pickup can be more cooled.

In the aforementioned structure having the air intake opening including the first air intake opening and the second intake opening, the second air intake opening is preferably formed to extend from the upstream side in the rotational direction of the disk rotated by the rotating portion toward the optical pickup arranged on the second position as the prescribed position. According to this structure, the disk unit can efficiently cool the optical pickup reaching a high temperature in both cases of applying light to the portion of the disk close to the center thereof and applying light to the portion of the disk close to the outer periphery thereof.

In the aforementioned structure having the air intake opening including the first air intake opening and the second intake opening, the first air intake opening and the second air intake opening are preferably provided substantially parallelly to each other. According to this structure, the first air intake opening and the second air intake opening can be inhibited from intersecting with each other, whereby both of the first air intake opening and the second air intake opening can be easily formed to extend from the upstream side toward the downstream side in the rotational direction of the disk rotated by the rotating portion.

In the disk unit according to the aforementioned aspect, the receiving region of the tray is preferably provided with a first region for receiving a first disk and a second region for receiving a second disk larger than the first disk, and the air intake opening of the tray is preferably formed to extend inward from outside the first region in the receiving region. According to this structure, the air intake opening is further increased in size as compared with a case where the same is formed within the first region, whereby the disk unit can further cool the optical pickup by incorporating a larger quantity of air from the air intake opening.

In this case, the air intake opening of the tray is preferably formed to extend inward from outside the first region and from inside the second region in the receiving region. According to this structure, the air intake opening can be increased in size not to be oversized, whereby the efficiency for cooling the optical pickup can be improved while suppressing reduction in mechanical strength of the tray.

In the disk unit according to the aforementioned aspect, the tray preferably includes a resin portion made of resin, and the air intake opening is preferably formed in the resin portion of the tray. According to this structure, the air intake opening can be easily formed in the easily workable resin portion.

In the disk unit according to the aforementioned aspect, the air intake opening is preferably formed to extend toward the optical pickup up to a portion close to the optical pickup. According to this structure, air incorporated (drawn) into the side of the receiving surface of the tray from the side of the back surface thereof through the air intake opening extending up to the portion close to the optical pickup can be guided to the optical pickup in a larger quantity, whereby the optical pickup can be more sufficiently cooled.

In the disk unit according to the aforementioned aspect, the air intake opening may be formed to extend toward the optical pickup with a substantially constant width.

In the disk unit according to the aforementioned aspect, the air intake opening is preferably formed to extend from a side of the rotation center of the disk opposite to a side where the optical pickup is arranged to the side where the optical pickup is arranged in the direction of movement of the optical pickup. According to this structure, the air intake opening can be easily formed to extend from the upstream side toward the downstream side in the rotational direction of the disk in the receiving region receiving the disk.

The disk unit according to the aforementioned aspect preferably further includes a cover portion provided to cover the tray, the rotating portion and the optical pickup. According to this structure, the disk unit can sufficiently cool the optical pickup easily reaching a high temperature, due to the cover portion covering the same.

In the disk unit according to the aforementioned aspect, the optical pickup preferably includes a plurality of irradiation lenses, to be applicable to a plurality of types of disks. According to this structure, the disk unit can sufficiently cool the optical pickup applicable to a plurality of types of disks such as a CD and a DVD.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of an optical disk unit according to a first embodiment of the present invention;

FIG. 2 is an exploded perspective view showing the overall structure of the optical disk unit according to the first embodiment of the present invention;

FIG. 3 is a plan view showing the overall structure of the optical disk unit according to the first embodiment of the present invention;

FIG. 4 is a perspective view of the optical disk unit according to the first embodiment of the present invention, from which a cover portion is detached;

FIG. 5 is a sectional view taken along the line 300-300 in FIG. 3;

FIG. 6 illustrates temperature distribution in an optical pickup of the optical disk unit according to the first embodiment of the present invention;

FIG. 7 illustrates temperature distribution in an optical pickup of an optical disk unit according to comparative example for the first embodiment of the present invention;

FIG. 8 illustrates flow velocity distribution in an air current on the upper surface of the optical pickup of the optical disk unit according to the first embodiment of the present invention;

FIG. 9 illustrates flow velocity distribution in an air current on the upper surface of the optical pickup of the optical disk unit according comparative example for the first embodiment of the present invention;

FIG. 10 is a plan view showing the overall structure of an optical disk unit according to a second embodiment of the present invention; and

FIG. 11 is a plan view showing a modification of the first embodiment of the present invention.

### DESCRIPTION OF THE PREFERRED EMBODIMENTS

Embodiments of the present invention are now described with reference to the drawings.

### First Embodiment

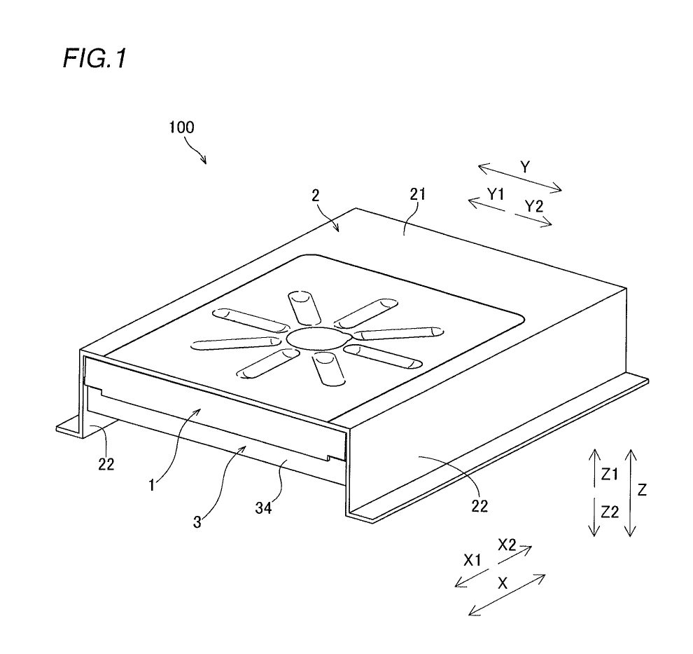

The structure of an optical disk unit 100 according to a first embodiment of the present invention is described with reference to FIG. 1. The optical disk unit 100 is an example of the “disk unit” according to the present invention.

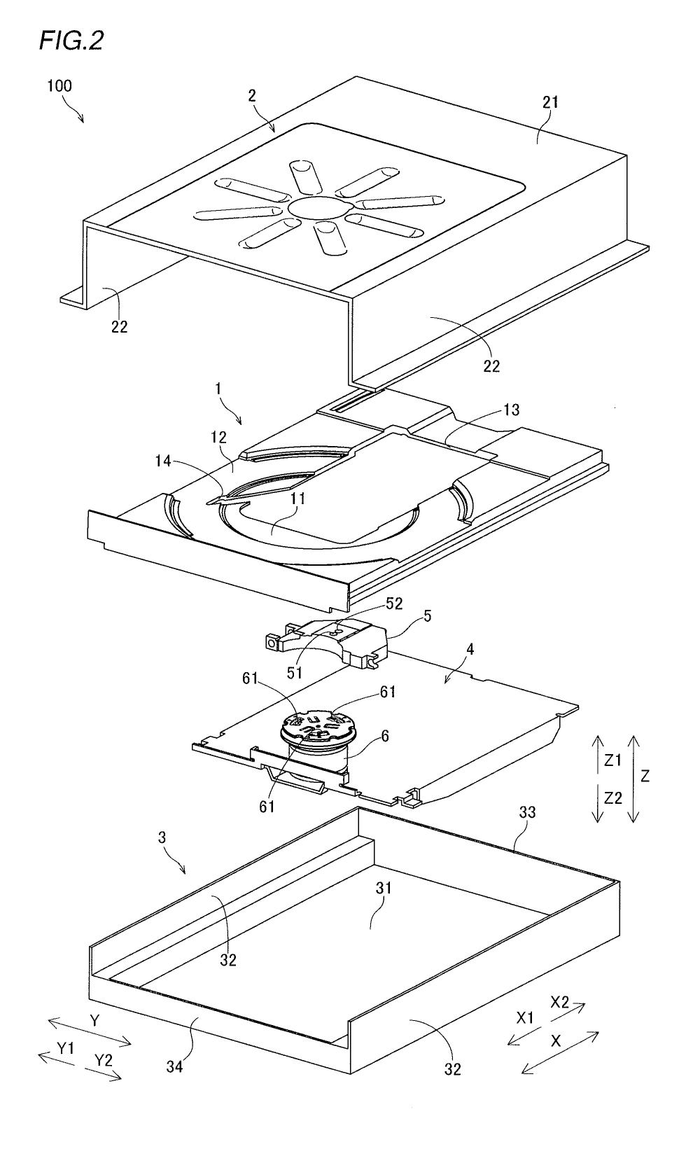

The optical disk unit 100 according to the first embodiment of the present invention includes a tray 1 for receiving an optical disk 110 (see FIG. 5) such as a CD or a DVD, a cover portion 2 arranged to cover the tray 1 from above, a loader chassis 3 storing the tray 1 and a traverse chassis 4 (see FIG. 2) arranged between the tray 1 and the loader chassis 3, as shown in FIGS. 1 and 2. The traverse chassis 4 is loaded with an optical pickup 5 applying a laser beam to the optical disk 110 and a disk rotating portion 6 rotating the optical disk 110. The disk rotating portion 6 is an example of the “rotating portion” in the present invention, and the optical disk 110 is an example of the “disk” in the present invention.

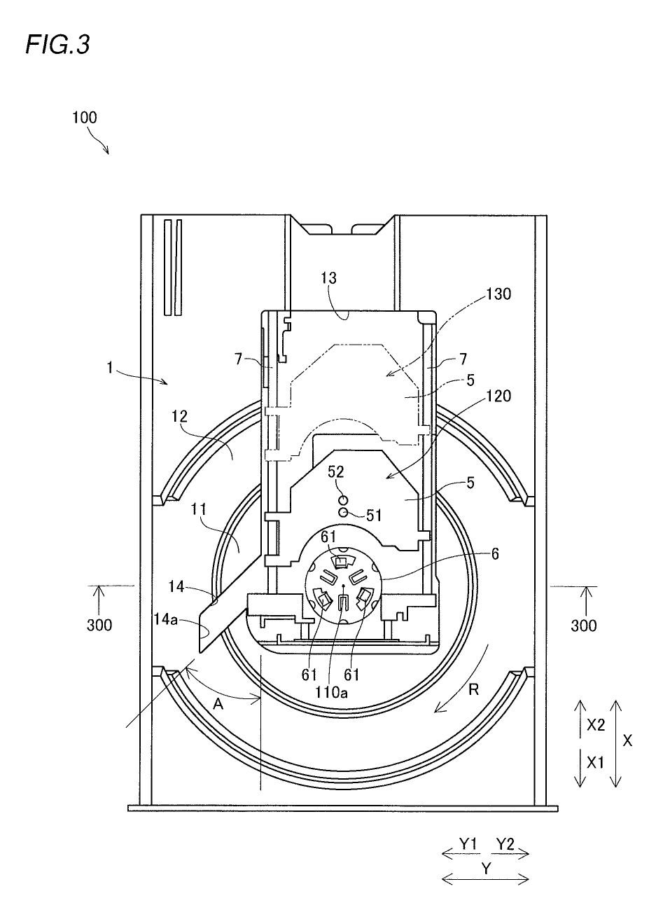

The tray 1 is formed to be movable by a moving mechanism (not shown) in a direction X with respect to the cover portion 2, the loader chassis 3 and the traverse chassis 4. More specifically, the tray 1 is moved to project along arrow X1 with respect to the cover portion 2, the loader chassis 3 and the traverse chassis 4 when the user introduces/ejects the optical disk 110 into/from the optical disk unit 100. When the user reproduces the optical disk 110 or records information in the optical disk 110, on the other hand, the tray 1 is stored in the loader chassis 3 and arranged on a position entirely covered with the cover portion 2. The tray 1 is integrally made of resin as a whole. A first region 11 for receiving a small-sized optical disk 110 (about 80 mm in diameter) and a second region 12 for receiving a large-sized optical disk 110 (about 120 mm in diameter) are provided on the upper surface (surface along arrow Z1) of the tray 1, as shown in FIG. 1. The first and second regions 11 and 12 are substantially circular in shape in plan view, and formed to be concentric with each other, as shown in FIG. 3. The first region 11 is concaved with respect to the second region 12. The second region 12 is concaved with respect to a region outside the second region 12.

The tray 1 is provided with a substantially rectangular exposing opening 13. The exposing opening 13 is provided for exposing the optical pickup 5 and the disk rotating portion 6 on the side of the upper surface (along arrow Z1) of the tray 1. The exposing opening 13 is formed to extend along arrow X2 from a side of the center of the first and second regions 11 and 12 (rotation center 110a of the optical disk 110) along arrow X1 up to the region outside the second region 12.

According to the first embodiment, the tray 1 is provided with an air intake opening 14 for drawing (incorporating) air into the upper side (along arrow Z1) of the tray 1 from the lower side (along Z2) thereof due to an air current resulting from rotation of the optical disk 110. The air intake opening 14 is in the form of a notch whose end portion along arrow Y2 is connected to the exposing opening 13.

The air intake opening 14 is formed to extend from an upstream side in the rotational direction (direction R) (clockwise in plan view) of the optical disk 110 toward the optical pickup 5. More specifically, the air intake opening 14 is formed to extend toward the optical pickup 5 arranged on an innermost position 120 for reading information recorded in the innermost side of the optical disk 110 (or for writing information in the innermost side of the optical disk 110). Further, the air intake opening 14 is formed to extend up to a portion close to the optical pickup 5. In addition, the air intake opening 14 is arranged along the direction (direction X) of movement of the optical pickup 5 described later. More specifically, the air intake opening 14 is formed to be inclined by a sharp angle A in the rotational (clockwise) direction of the optical disk 110 with respect to the direction (direction X) of movement of the optical pickup 5 in plan view. Further, the air intake opening 14 is formed to extend inward from outside a receiving region for receiving the optical disk 110 from the upstream side toward a downstream side in the rotational direction of the optical disk 110.

More specifically, the air intake opening 14 is arranged on a side of the center of the first and second regions 11 and 12 (rotation center 110a of the optical disk 110) along arrow Y1. In other words, the air intake opening 14 is arranged on the upstream side in the rotational direction of the optical disk 110 with respect to the optical pickup 5. An end portion 14a of the air intake opening 14 along arrow Y1 is arranged on a side of the rotation center 100a along arrow X1, oppositely to the side where the optical pickup 5 is arranged. Further, the air intake opening 14 is provided on a side of the center of the optical pickup 5 along arrow X1 in plan view. The end portion 14a of the air intake opening 14 along arrow Y1 is positioned outside the first region 11 and inside the outer edge of the second region 12 (within the second region 12). Further, the end portion 14a of the air intake opening 14 along arrow Y1 is formed substantially parallelly to the direction (direction X) of movement of the optical pickup 5. The air intake opening 14 is formed with a substantially constant width (about 10 mm). Further, the air intake opening 14 is formed to extend from the side (along arrow X1) of the rotation center 110a of the optical disk 110 opposite to the side where the optical pickup 5 is arranged to the side (along arrow X2) where the optical pickup 5 is arranged in the direction (direction X) of movement of the optical pickup 5.

The cover portion 2 is provided for covering the tray 1, the loader chassis 3, the traverse chassis 4, the optical pickup 5 and the disk rotating portion 6 from above, as shown in FIGS. 1 and 2. More specifically, the cover portion 2 includes a flat top plate 21 having a substantially rectangular shape, side portions 22 extending downward (along arrow Z2) from both sides of the top plate portion 21 in a direction Y and a back surface portion (not shown) extending downward from the rear end portion (end portion along arrow X2) of the top plate portion 21. Thus, the cover portion 2 can inhibit grit, dust or the like from entering the optical disk 100. In the cover portion 2, the top plate portion 21, the side portions 22 and the back surface portion are integrally made of sheet metal.

The loader chassis 3 is provided for holding the tray 1 and the traverse chassis 4. The loader chassis 3 is in the form of a box, as shown in FIG. 2. More specifically, the loader chassis 3 includes a flat bottom surface portion 31 having a substantially rectangular shape, side portions 32 provided on both sides of the loader chassis 3 in the direction Y to extend upward (along arrow Z2), a back surface portion 33 extending upward from the rear end portion (end portion along arrow X2) of the bottom surface portion 31 and a front surface portion 34 extending upward from the front end portion (end portion along arrow X1) of the bottom surface portion 31. The height of the front surface portion 34 is substantially half that of the side portions 32 and the back surface portion 33. According to the aforementioned structure, the loader chassis 3 is capable of storing the tray 1, the traverse chassis 4, the optical pickup 5 and the disk rotating portion 6 therein. In the loader chassis 3, the bottom surface portion 31, the side portions 32, the back surface portion 33 and the front surface portion 34 are integrally made of sheet metal.

The traverse chassis 4 is provided to be loaded with the optical pickup 5 and the disk rotating portion 6, as shown in FIG. 2. The traverse chassis 4 has a function of vertically moving the optical pickup 5 and the disk rotating portion 6 placed on the side of the upper surface thereof with a moving mechanism (not shown).

The optical pickup 5 is arranged on the traverse chassis 4. The optical pickup 5 is formed to read information recorded in the optical disk 110 or to write information in the optical disk 110 by applying a laser beam to the lower surface (surface placed on a receiving surface of the tray 1) of the optical disk 110 (see FIG. 5). More specifically, the optical pickup 5 has two irradiation lenses 51 and 52 for a CD and a DVD respectively, as shown in FIGS. 2 and 3. Thus, the optical disk unit 100 is applicable to both of optical disks 110 formed by a CD and a DVD respectively.

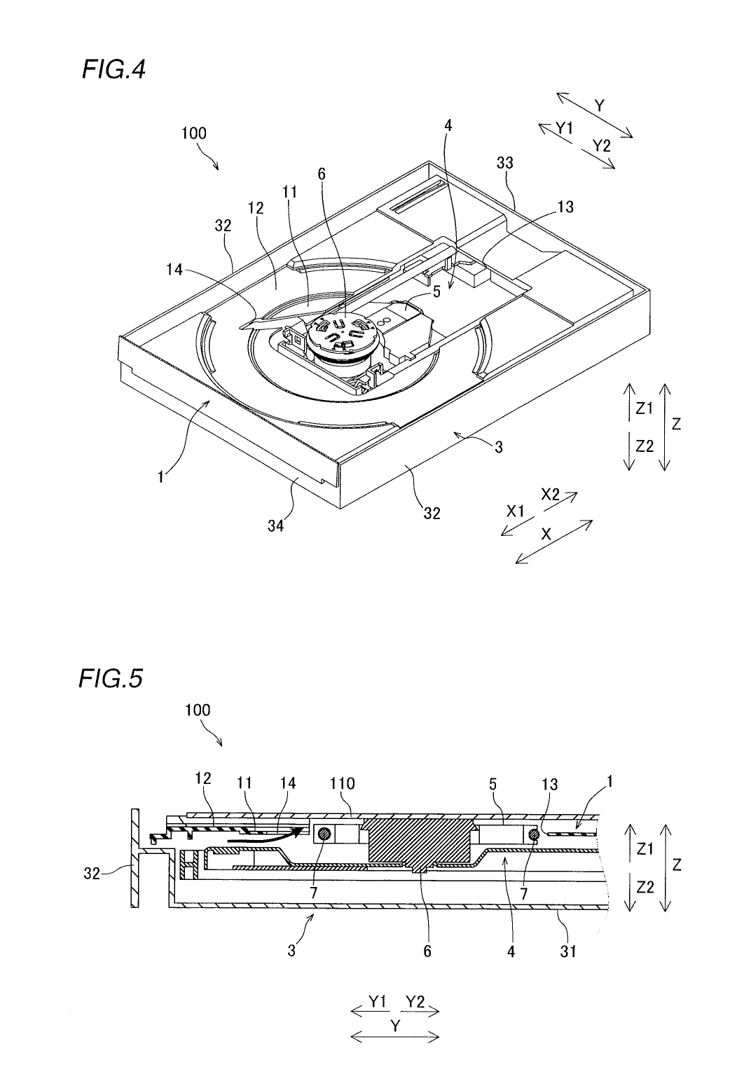

The optical pickup 5 is arranged on a side of the disk rotating portion 6 along arrow X2, as shown in FIGS. 3 and 4. Further, the optical pickup 5 is formed to be movable in the direction X along a pair of guide rails 7 on the side of the disk rotating portion 6 along arrow X2. More specifically, the optical pickup 5 is formed to be linearly moved between the innermost position 120 for reading information recorded in the innermost side of the optical disk 110 (or for writing information in the innermost side of the optical disk 110) and an outermost position 130 for reading information recorded in the outermost side of the optical disk 110 (or for writing information in the outermost side of the optical disk 110) in the direction X, as shown in FIG. 3. The innermost position 120 is an example of the “first position” in the present invention, and the outermost position 130 is an example of the “second position” in the present invention. In the optical disk unit 100 according to the first embodiment, the optical pickup 5 reaches the highest temperature when located on the innermost position 120.

The disk rotating portion 6 is arranged on the upper surface of the traverse chassis 4. Further, the disk rotating portion 6 is arranged on the center of the first and second regions 11 and 12. In addition, the disk rotating portion 6 has a function of supporting the center of the optical disk 110 and rotating the optical disk 110 in a direction R (clockwise in plan view). More specifically, the disk rotating portion 6 has engaging portions 61 engaging with the inner edge of the optical disk 110, and is formed to fix and support the optical disk 110 with the engaging portions 61. Further, the disk rotating portion 6 is formed to lift up the optical disk 110 following upward movement (along arrow Z1) of the traverse chassis 4 in the state supporting the optical disk 110. Thus, the optical disk 110 supported by the disk rotating portion 6 is separated from the receiving surface (surface along arrow Z1) of the tray 1. The disk rotating portion 6 is formed to rotate the optical disk 110 in the direction R (clockwise in plan view) in this state. In other words, the optical disk 110 is rotated in the direction R in the state separated from the tray 1.

The state of the optical disk unit 100 according to the first embodiment rotating the optical disk 110 is now described with reference to FIG. 5.

As hereinabove described, the disk rotating portion 6 rotates the optical disk 110 in the direction R (clockwise in plan view) (see FIG. 3) in the state separated from the tray 1. At this time, an air current is formed between the optical disk 110 and the receiving surface (surface along arrow Z1) of the tray 1 in a direction substantially identical to the rotational direction (direction R) of the optical disk 110, due to the rotation of the optical disk 110. This air current passes through the surface of the optical pickup 5 exposed on the exposing opening 13 of the tray 1, to cool the optical pickup 5.

According to the first embodiment, the air current formed in an upper portion of the tray 1 (along arrow Z1) draws air in a lower portion of the tray 1 (along arrow Z2) into the upper portion (along arrow Z1) of the tray 1 through the air intake opening 14, as shown by a thick arrow in FIG. 5. In other words, the air current resulting from the rotation of the optical disk 110 swallows up (incorporates) the air in the lower portion of the tray 1, to be formed by a larger quantity of air.

According to the first embodiment, as hereinabove described, the optical disk unit 100 is provided with the air intake opening 14 for incorporating air into the side of the receiving surface (along arrow Z1) of the tray 1 from the side of the back surface (along arrow Z2) thereof in the receiving region for receiving the optical disk 110, whereby air can be incorporated (drawn) into the side of the receiving surface of the tray 1 from the side of the back surface thereof through the air intake opening 14, due to the air current formed between the optical disk 110 and the receiving surface (surface along arrow Z1) of the optical disk 110 following the rotation of the optical disk 110. Further, the air intake opening 14 is formed to extend from the upstream side in the rotational direction (direction R) of the optical disk 110 rotated by the disk rotating portion 6 toward the optical pickup 5 and to extend inward from outside the receiving region from the upstream side toward the downstream side in the rotational direction in the receiving region for receiving the optical disk 110 so that air incorporated from the air intake opening 14 extending toward the optical pickup 5 is intensively guided to the optical pickup 5 located on the downstream side of the air intake opening 14, whereby the optical pickup 5 can be sufficiently cooled dissimilarly to a case where the air intake opening 14 is formed to extend parallelly to the direction of movement of the optical pickup 5 and the air incorporated through the air intake opening 14 is dispersed, for example. The effect of the optical disk unit 100 capable of cooling the optical pickup 5 has already been confirmed by a simulation conducted by the inventor, as described later.

According to the first embodiment, the air intake opening 14 of the tray 1 is in the form of a notch connected to the exposing opening 13 in a portion of the air intake opening 14 on the downstream side so that no separating portion (separating wall) is provided between the air intake opening 14 and the exposing opening 13 dissimilarly to a case where the air intake opening 14 and the exposing opening 13 are separated from each other and hence air incorporated through the air intake opening 14 is guided to the optical pickup 5 exposed in the exposing opening 13 in a larger quantity, whereby the optical pickup can be sufficiently cooled.

According to the first embodiment, the air intake opening 14 of the tray 1 is formed to extend from the upstream side in the rotational direction (direction R) of the optical disk 110 rotated by the disk rotating portion 6 toward the optical pickup 5 arranged on the innermost position 120 so that air is intensively guided to the optical pickup 5 located on the innermost position 120 on a movement path, whereby the optical disk unit 100 can efficiently cool the optical pickup 5 reaching a high temperature on the innermost position 120.

According to the first embodiment, the tray 1 is provided with the first region 11 for receiving the small-sized optical disk 110 and the second region 12 for receiving the large-sized optical disk 110 and the air intake opening 14 is formed to extend inward from outside the first region 11 so that the air intake opening 14 is increased in size as compared with a case where the same is formed only in the first region 11, whereby the optical disk unit 100 can further cool the optical pickup 5 by incorporating a larger quantity of air through the air intake opening 14.

According to the first embodiment, the overall tray 1 is made of resin, whereby the air intake opening 14 can be easily formed in an easily workable resin portion.

According to the first embodiment, the air intake opening 14 of the tray 1 is formed outside the first region 11 to extend inward from inside the second region 12 so that the air intake opening 14 can be increased in size not to be oversized, whereby the efficiency for cooling the optical pickup 5 can be improved while suppressing reduction in mechanical strength of the tray 1.

According to the first embodiment, the air intake opening 14 is formed to extend toward the optical pickup 5 up to the portion close to the optical pickup 5 so that air incorporated (drawn) into the side of the receiving surface of the tray 1 from the side of the back surface thereof through the air intake opening 14 extending up to the portion close to the optical pickup 5, whereby the optical pickup 5 can be more sufficiently cooled.

According to the first embodiment, the air intake opening 14 is formed to extend from the side (along arrow X1) of the rotation center 110a of the optical disk 110 opposite to the side where the optical pickup 5 is arranged to the side (along arrow X2) where the optical pickup 5 is arranged in the direction (direction X) of movement of the optical pickup 5. According to this structure, the air intake opening 14 can be easily formed to extend from the upstream side toward the downstream side in the rotational direction of the optical disk 110 in the receiving region (first and second regions 11 and 12) for receiving the optical disk 110.

Results of the simulation conducted in order to confirm the effects of the optical disk unit 100 according to the aforementioned first embodiment are now described in detail.

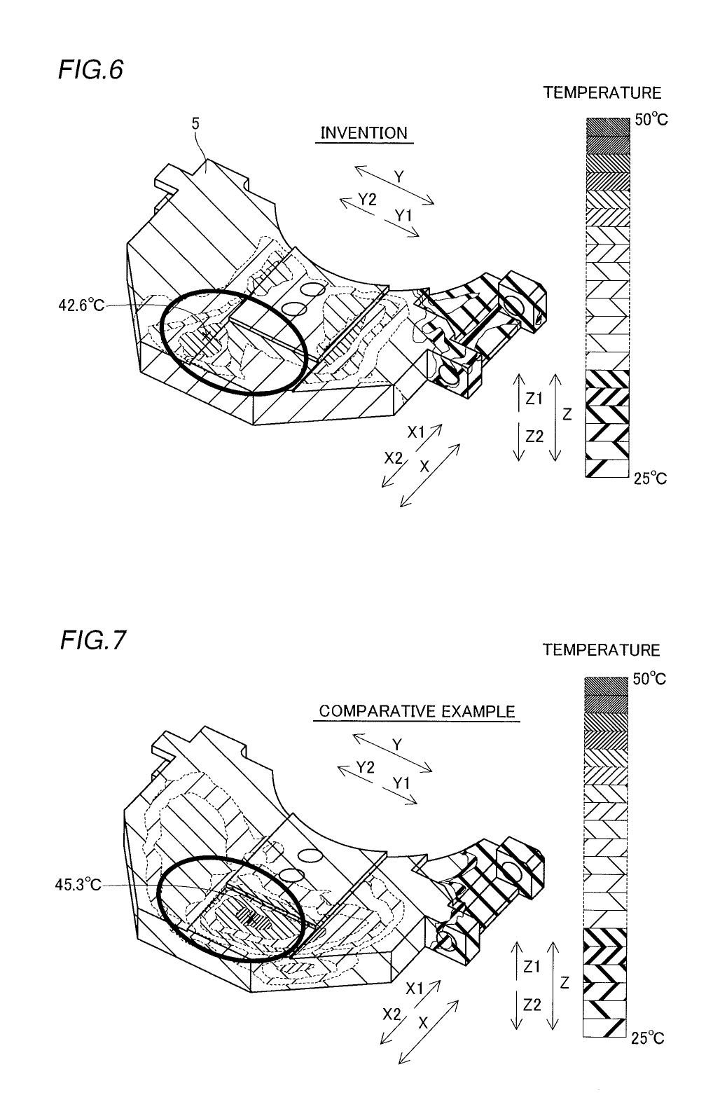

FIG. 6 illustrates temperature distribution in the optical pickup 5 of the optical disk unit 100 according to the first embodiment of the present invention, and FIG. 7 illustrates temperature distribution in an optical pickup of an optical disk unit according to comparative example, provided with a tray having no air intake opening. Simulation conditions for the optical disk unit 100 according to the first embodiment of the present invention and the optical disk unit according to comparative example were similarly set, except that the tray of the optical disk unit according to comparative example had no air intake opening. More specifically, optical disks were rotated in the optical disk unit 100 according to the first embodiment of the present invention and the optical disk unit according to comparative example while applying heat of 1 Ws to the optical pickups, which were both made of iron. In each of the optical disk unit 100 according to the first embodiment of the present invention and the optical disk unit according to comparative example, the simulation was continued until the temperature distribution was stabilized. The air intake opening 14 of the optical disk unit 100 according to the first embodiment of the present invention was set to an angle A (see FIG. 3) of 30° with respect to the direction (direction X) of movement of the optical pickup 5.

It is understood from FIGS. 6 and 7 that the optical pickup 5 of the optical disk unit 100 according to the first embodiment of the present invention is wholly lower in temperature than the optical pickup of the optical disk unit according to comparative example. In particular, the optical pickup 5 of the optical disk unit 100 according to the first embodiment of the present invention is remarkably lower in temperature than the optical pickup of the optical disk unit according to comparative example in the portion (enclosed with a thick line) close to the center of the optical pickup 5. While the maximum temperature of the optical pickup of the optical disk unit according to comparative example is 45.3° C., that of the optical pickup 5 of the optical disk unit 100 according to the first embodiment of the present invention is 42.6° C., which is lower by 2.7° C. than the maximum temperature of the optical pickup of the optical disk unit according to comparative example. Thus, it is understood that the effect of cooling the optical pickup 5 is improved due to the air intake opening 14 provided on the tray 1.

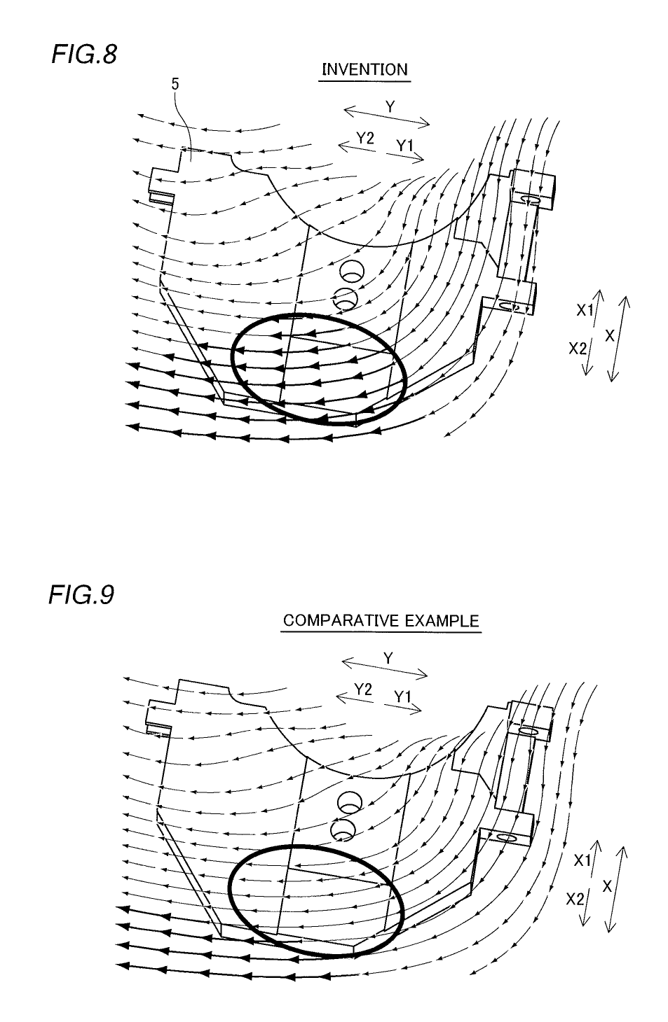

FIG. 8 illustrates flow velocity distribution in the air current on the upper surface of the optical pickup 5 of the optical disk unit 100 according to the first embodiment of the present invention, and FIG. 9 illustrates flow velocity distribution in an air current on the upper surface of the optical pickup of the optical disk unit according to comparative example provided with the tray having no air intake opening. FIGS. 8 and 9 show relatively large flow velocities exceeding 4 m/s with thick arrows.

It is understood from FIGS. 8 and 9 that the air current is wholly larger in flow velocity (with a larger number of thick arrows) on the upper surface of the optical pickup 5 of the optical disk unit 100 according to the first embodiment of the present invention than on the upper surface of the optical pickup of the optical disk unit according to comparative example. In particular, the air current is remarkably larger in flow velocity on the upper surface of the optical pickup 5 of the optical disk unit 100 according to the first embodiment of the present invention as compared with that on the upper surface of the optical pickup of the optical disk unit according to comparative example in the portion (enclosed with a thick line) close to the center of the optical pickup 5. Thus, it is conceivable that the optical disk unit 100 according to the first embodiment of the present invention was more improved in cooling efficiency as compared with the optical disk unit according to comparative example. It is also conceivable that air in the lower portion of the tray 1 was drawn (incorporated) into the upper portion of the tray 1 from the air intake opening 14 due to the air current resulting from rotation of the optical disk 110, to increase the flow velocity of the air current on the upper surface of the optical pickup 5.

### Second Embodiment

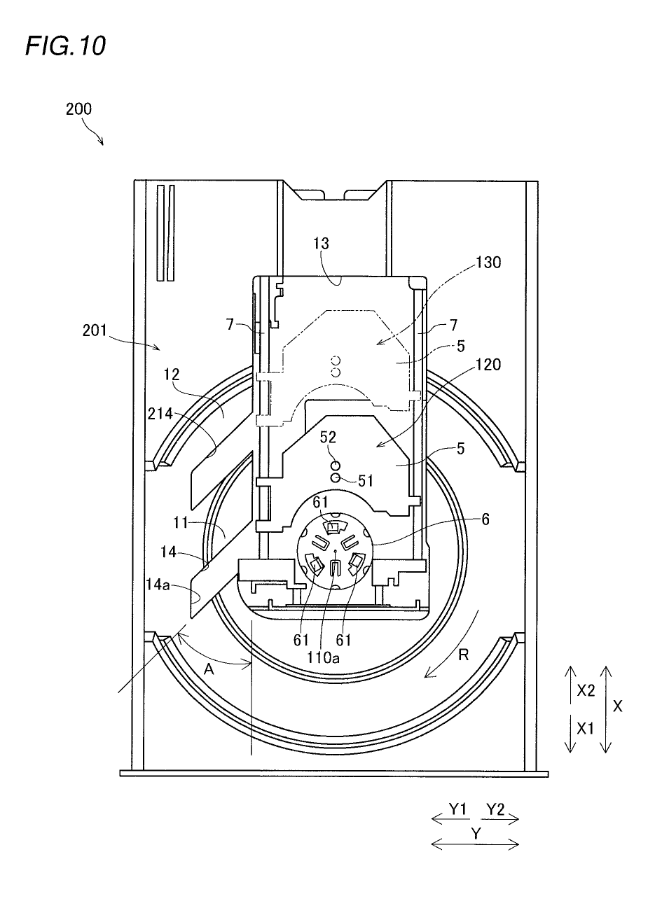

An optical disk unit 200 according to a second embodiment of the present invention is now described. According to the second embodiment, the optical disk unit 200 has a tray 201 provided with two air intake openings 14 and 214 as shown in FIG. 10, dissimilarly to the aforementioned first embodiment. The optical disk unit 200 is an example of the “disk unit” according to the present invention.

The optical disk unit 200 according to the second embodiment of the present invention includes the tray 201 having the two air intake openings 14 and 214, as shown in FIG. 10. More specifically, the tray 201 is provided with the air intake opening 14, similar to the air intake opening 14 of the tray 1 in the optical disk unit 100 according to the aforementioned first embodiment, formed to extend toward an optical pickup 5 located on an innermost position 120 and the air intake opening 214 formed to extend toward the optical pickup 5 located on an outermost position 130. The two air intake openings 14 and 214 are similar in shape to each other. The air intake opening 214 is arranged on a position translated from that of the air intake opening 14 along arrow X2 by the distance between the innermost and outermost positions 120 and 130. In other words, the two air intake openings 14 and 214 are provided parallelly to each other. The air intake opening 14 is an example of the “first air intake opening” in the present invention, and the air intake opening 214 is an example of the “second air intake opening” in the present invention.

The remaining structure of the second embodiment is similar to that of the aforementioned first embodiment.

According to the second embodiment, as hereinabove described, the tray 201 is provided with the air intake opening 14 formed to extend from an upstream side in a rotational direction (direction R) of an optical disk 110 rotated by a disk rotating portion 6 toward the optical pickup 5 arranged on the innermost position 120 and the air intake opening 214 formed to extend from the upstream side in the rotational direction of the optical disk 110 rotated by the disk rotating portion 6 toward the optical pickup 5 arranged on the outermost position 130, whereby the optical disk unit 200 can efficiently cool the optical pickup 5 reaching a high temperature on both of the innermost position 120 and the outermost position 130.

The remaining effects of the second embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

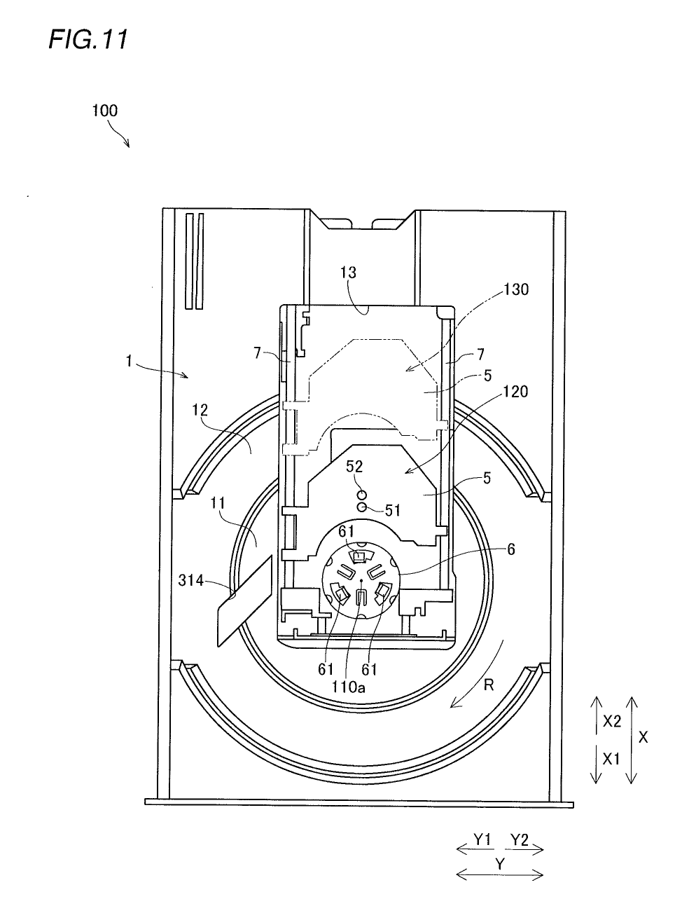

For example, while the air intake opening(s) is in the form of a notch in each of the aforementioned first and second embodiments, the present invention is not restricted to this. According to the present invention, an air intake opening 314 may alternatively be in the form of a slit (not connected to an exposing opening), as shown in FIG. 11.

While the end portion 14a of the air intake opening 14 along arrow Y1 is arranged outside the first region 11 and inside the second region 12 in each of the aforementioned first and second embodiments, the present invention is not restricted to this. According to the present invention, the end portion 14a of the air intake opening 14 along arrow Y1 may alternatively be arranged inside the first region 12, or outside the second region 12.

While the overall tray is made of resin in each of the aforementioned first and second embodiments, the present invention is not restricted to this. According to the present invention, the tray may alternatively be only partially made of resin. In this case, the air intake opening is preferably formed on the portion made of resin.

While the air intake opening is formed to extend toward the optical pickup located on the innermost position in the aforementioned first embodiment, the present invention is not restricted to this. According to the present invention, the air intake opening may alternatively be formed to extend toward the optical pickup located on a position, such as the outermost position, for example, other than the innermost position, or to extend toward the optical pickup located on a position other than the innermost and outermost positions.

While the tray is provided with the two air intake openings in the aforementioned second embodiment, the present invention is not restricted to this. According to the present invention, the tray may alternatively be provided at least three air intake openings.

While the exposing opening is formed to expose both of the optical pickup and the disk rotating portion on the side of the receiving surface (upper surface) of the tray in each of the aforementioned first and second embodiments, the present invention is not restricted to this. According to the present invention, the exposing opening may simply be provided in a shape capable of exposing at least the optical pickup.

What is claimed is:

1. A disk unit comprising:
a tray capable of receiving a disk thereon;
a rotating portion supporting said disk placed on said tray to be separated from a receiving surface of said tray and rotating supported said disk; and
an optical pickup arranged on a side of said disk closer to said receiving surface for applying light to said disk, wherein
said tray has an air intake opening formed to extend from an upstream side in a rotational direction of said disk rotated by said rotating portion toward said optical pickup in a receiving region receiving said disk and to extend inward from outside said receiving region from said upstream side toward a downstream side in said rotational direction for incorporating air into the side of said receiving surface of said tray from the side of the back surface of said tray opposite to said receiving surface.

2. The disk unit according to claim 1, wherein
said optical pickup is formed to be movable in the radial direction of said disk, and
said air intake opening of said tray is formed to extend from said upstream side in said rotational direction of said disk toward said optical pickup at a sharp angle in said rotational direction of said disk with respect to the direction of movement of said optical pickup.

3. The disk unit according to claim 1, wherein
said tray further has an exposing opening for exposing at least said optical pickup on the side of said receiving surface of said tray, and
said air intake opening of said tray is in the form of a notch connected to said exposing opening in a portion of said air intake opening on said downstream side.

4. The disk unit according to claim 3, wherein
said exposing opening is provided in a shape capable of exposing both of said rotating portion and said optical pickup on the side of said receiving surface of said tray.

5. The disk unit according to claim 1, wherein
said optical pickup is formed to be movable in the radial direction of said disk, and
said air intake opening is formed to extend toward a prescribed position on a movement path of said optical pickup.

6. The disk unit according to claim 5, wherein
said optical pickup is formed to be movable between a first position on which said optical pickup is arranged when applying light to a portion of said disk close to the center thereof and a second position on which said optical pickup is arranged when applying light to another portion of said disk close to the outer periphery thereof, and
said air intake opening of said tray includes at least a first air intake opening formed to extend from said upstream side in said rotational direction of said disk rotated by said rotating portion toward said optical pickup arranged on said first position as said prescribed position.

7. The disk unit according to claim 6, wherein
said air intake opening of said tray further includes a second air intake opening formed to extend from said upstream side in said rotational direction of said disk rotated by said rotating portion toward said optical pickup, in addition to said first air intake opening.

8. The disk unit according to claim 7, wherein
said second air intake opening is formed to extend from said upstream side in said rotational direction of said disk rotated by said rotating portion toward said optical pickup arranged on said second position as said prescribed position.

9. The disk unit according to claim 7, wherein
said first air intake opening and said second air intake opening are provided substantially parallelly to each other.

10. The disk unit according to claim 1, wherein
said receiving region of said tray is provided with a first region for receiving a first disk and a second region for receiving a second disk larger than said first disk, and
said air intake opening of said tray is formed to extend inward from outside said first region in said receiving region.

11. The disk unit according to claim 10, wherein
said air intake opening of said tray is formed to extend inward from outside said first region and from inside said second region in said receiving region.

12. The disk unit according to claim 1, wherein
said tray includes a resin portion made of resin, and
said air intake opening is formed in said resin portion of said tray.

13. The disk unit according to claim 1, wherein
said air intake opening is formed to extend toward said optical pickup up to a portion close to said optical pickup.

14. The disk unit according to claim 1, wherein
said air intake opening is formed to extend toward said optical pickup with a substantially constant width.

15. The disk unit according to claim 1, wherein
said air intake opening is formed to extend from a side of the rotation center of said disk opposite to a side where said optical pickup is arranged to said side where said optical pickup is arranged in the direction of movement of said optical pickup.

16. The disk unit according to claim 1, further comprising a cover portion provided to cover said tray, said rotating portion and said optical pickup.

17. The disk unit according to claim 1, wherein
said optical pickup includes a plurality of irradiation lenses, to be applicable to a plurality of types of disks.
